(19) United States
(12) Patent Application Publication
(10) Pub. No.: US 2026/0257972 A1
(43) Pub. Date: Sep. 3, 2026

(54) BONDCOAT INCLUDING AN OXYGEN GETTER

(71) Applicant: General Electric Company, Evendale, OH (US)

(72) Inventor: Julin Wan, Rexford, NY (US)

(21) Appl. No.: 19/066,797

(22) Filed: Feb. 28, 2025

(51) Int. Cl. C04B 35/565; C04B 35/52; C04B 35/64; C04B 41/00; C04B 41/52; C04B 41/89

(52) U.S. Cl. CPC C04B 35/565; C04B 35/52; C04B 35/64; C04B 41/0072; C04B 41/52; C04B 41/89; C04B 2235/3463; C04B 2235/3826; C04B 2235/428; C04B 2235/656; C04B 2235/668

(57) ABSTRACT

Coated components, along with their methods of formation, are provided. The coated component includes: a ceramic matrix composite substrate comprising silicon carbide and having a surface; a bondcoat on the surface of the ceramic matrix composite substrate; and an environmental barrier coating on the bondcoat. The bondcoat comprises a matrix phase having a plurality of oxygen getter particulates dispersed within the matrix phase and having a plurality of pores dispersed within the matrix phase such that a majority of the oxygen getter particulates are disposed within a respective pore of the plurality of pores.

### FIELD

The present disclosure generally relates to bondcoats for use with environmental barrier coatings on ceramic components, particularly silicon-based ceramic matrix components, along with methods of their formation and use.

### BACKGROUND

Higher operating temperatures for gas turbine engines are continuously being sought in order to improve their efficiency. However, as operating temperatures increase, the high temperature durability of the components of the engine must correspondingly increase. Significant advances in high temperature capabilities have been achieved through the formulation of iron, nickel, and cobalt-based superalloys. Still, with many hot gas path components constructed from super alloys, thermal barrier coatings (TBCs) can be utilized to insulate the components and can sustain an appreciable temperature difference between the load-bearing alloys and the coating surface, thus limiting the thermal exposure of the structural component.

While superalloys have found wide use for components used throughout gas turbine engines, and especially in the higher temperature sections, alternative lighter-weight substrate materials have been proposed, such as ceramic matrix composite (CMC) materials, in particular silicon carbide (SiC) fiber reinforced SiC and SiC-Si matrix composites, so called SiC/SiC composites. CMC and monolithic ceramic components can be coated with environmental barrier coatings (EBCs) to protect them from the harsh environment of high temperature engine sections. EBCs can provide a dense, hermetic seal against the corrosive gases in the hot combustion environment.

Silicon carbide and silicon nitride ceramics undergo oxidation in dry, high temperature environments. This oxidation produces a passive, silicon oxide scale on the surface of the material. In moist, high temperature environments containing water vapor, such as a turbine engine, both oxidation and recession occurs due to the formation of a passive silicon oxide scale and subsequent conversion of the silicon oxide to gaseous silicon hydroxide. To prevent recession in moist, high temperature environments, environmental barrier coatings (EBC's) are deposited onto silicon carbide and silicon nitride materials.

Currently, EBC materials are made out of rare earth silicate compounds. These materials seal out water vapor, preventing it from reaching the silicon oxide scale on the silicon carbide or silicon nitride surface, thereby preventing recession. Such materials cannot prevent oxygen penetration, however, which results in oxidation of the underlying substrate. Oxidation of the substrate yields a passive silicon oxide scale, along with the release of carbonaceous or nitrous oxide gas. The carbonaceous (i.e., CO, CO₂) or nitrous (i.e., NO, NO₂, etc.) oxide gases cannot escape out through the dense EBC and thus, blisters form, which can cause spallation of the EBC. The use of a silicon bondcoat has been the solution to this blistering problem to date. The silicon bondcoat provides a layer that oxidizes (forming a passive silicon oxide layer beneath the EBC) without liberating a gaseous by-product.

### BRIEF DESCRIPTION OF THE DRAWINGS

A full and enabling disclosure of the present disclosure, including the best mode thereof, directed to one of ordinary skill in the art, is set forth in the specification, which makes reference to the appended Figs., in which:

FIG. 1 is a cross-sectional side view of an exemplary coated component including a bondcoat having a plurality of oxygen getter particulates dispersed within a matrix phase along with a plurality of pores;

FIG. 2A is a close-up cross-sectional side view of an exemplary as-deposited bondcoat mixture including a plurality of bimodal particles, shown as core-shell particles, dispersed within a matrix material;

FIG. 2B is a close-up cross-sectional side view of the exemplary bondcoat mixture of FIG. 2A after a first heat treatment has been performed to sufficiently remove sacrificial material from the bimodal particles to form a pore therein;

FIG. 2C is a close-up cross-sectional side view of the exemplary bondcoat mixture of FIG. 2B after a second heat treatment has been performed to densify the matrix phase to form a bondcoat having a matrix phase with a plurality of oxygen getter particulates dispersed and a plurality of pores distributed therein;

FIG. 3A is a close-up cross-sectional side view of an exemplary as-deposited bondcoat mixture including a plurality of bimodal particles, shown as intermixed particles, dispersed within a matrix material;

FIG. 3B is a close-up cross-sectional side view of the exemplary bondcoat mixture of FIG. 3A after a first heat treatment has been performed to sufficiently remove sacrificial material from the bimodal particles to form a pore therein;

FIG. 3C is a close-up cross-sectional side view of the exemplary bondcoat mixture of FIG. 3B after a second heat treatment has been performed to densify the matrix phase to form a bondcoat having a matrix phase with a plurality of oxygen getter particulates dispersed and a plurality of pores distributed therein;

FIG. 4 is a schematic cross-sectional view of an exemplary gas turbine engine according to various embodiments of the present subject matter; and

FIG. 5 is a diagram of an exemplary method of forming a bondcoat having a matrix phase with a plurality of oxygen getter particulates dispersed and a plurality of pores distributed therein.

Repeat use of reference characters in the present specification and drawings is intended to represent the same or analogous features or elements of the present disclosure.

### DEFINITIONS

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

As used herein, the terms “first”, “second”, and “third” may be used interchangeably to distinguish one component from another and are not intended to signify location or importance of the individual components.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth. As used herein, “RE” refers to a rare earth element or a mixture of rare earth elements. More specifically, “RE” refers to the rare earth elements of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or mixtures thereof.

As used herein, “alumina” refers to an aluminum oxide in the form of Al₂O₃.

As used herein, “silica” refers to a silicon oxide in the form of SiO₂.

Conversely, “elemental silicon” refers to silicon without any alloying materials present, outside of incidental impurities. It is sometimes referred to in the art as “silicon metal.” Elemental silicon has a melting point of about 1414° C.

As used herein, the term “mullite” generally refers to a mineral containing alumina and silica. That is, mullite is a chemical compound of alumina and silica with an alumina (Al₂O₃) and silica (SiO₂) ratio of about 3 to 2 (e.g., within 10 mole % of 3 to 2 of alumina to silica). However, a ratio of about 2 to 1 has also been reported as mullite (e.g., within 10 mole % of 2 to 1 of alumina to silica).

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix. Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC-SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing and subsequent chemical processing to arrive at a component formed of a CMC material having a desired chemical composition. For example, the preform may undergo a cure or burn-out to yield a high char residue in the preform, and subsequent melt-infiltration with silicon, or a cure or pyrolysis to yield a silicon carbide matrix in the preform, and subsequent chemical vapor infiltration with silicon carbide. Additional steps may be taken to improve densification of the preform, either before or after chemical vapor infiltration, by injecting it with a liquid resin or polymer followed by a thermal processing step to fill the voids with silicon carbide. CMC material as used herein may be formed using any known or hereinafter developed methods including but not limited to melt infiltration, chemical vapor infiltration, polymer impregnation pyrolysis (PIP), or any combination thereof.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer.

As used herein, environmental-barrier-coating or “EBC” refers to a coating system comprising one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), alkaline earth aluminosilicates (e.g., comprising barium-strontium-aluminum silicate (BSAS), such as having a range of BaO, SrO, Al₂O₃, and/or SiO₂ compositions), hermetic layers (e.g., a rare earth disilicate), and/or outer coatings (e.g., comprising a rare earth monosilicate, such as slurry or APS-deposited yttrium monosilicate (YMS)). One or more layers may be doped as desired, and the EBC may also be coated with an abradable coating.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries. The term “polymeric material” refers to any material that is based on a polymer.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The presence of a silicon-based bondcoat limits the upper temperature of operation for the EBC because the melting point of silicon metal is relatively low, at about 1414° C. Above these melting temperatures, the silicon bondcoat may delaminate from the underlying substrate, effectively removing the bondcoat and the EBC thereon. Mullite-containing bondcoats may be utilized to increase the operational temperature of the bondcoat. When mullite and Si are the only components of the bondcoat, it has been thought that highly densified bondcoats are needed, such as via pressurized sintering to achieve near-full density or using sintering aids added to the mullite/Si bondcoat to facilitate liquid phase sintering to obtain near-full density.

A coated component is generally provided that includes a bondcoat having a plurality of oxygen getter particulates dispersed within a matrix phase and having a plurality of pores dispersed within the matrix phase such that a majority of the oxygen getter particulates are disposed within a pore of the plurality of pores. For example, the plurality of pores may encase a majority of the oxygen getter particulates within the matrix phase. The bondcoat is generally positioned between the surface of the substrate and an environmental barrier coating (EBC) thereon. Without wishing to be bound by any particular theory, it is believed that the plurality of pores add a measure of mechanical compliance to the coating to allow accommodation of strains due to thermal stresses among the various materials present in the coating system and between the substrate and the coating system.

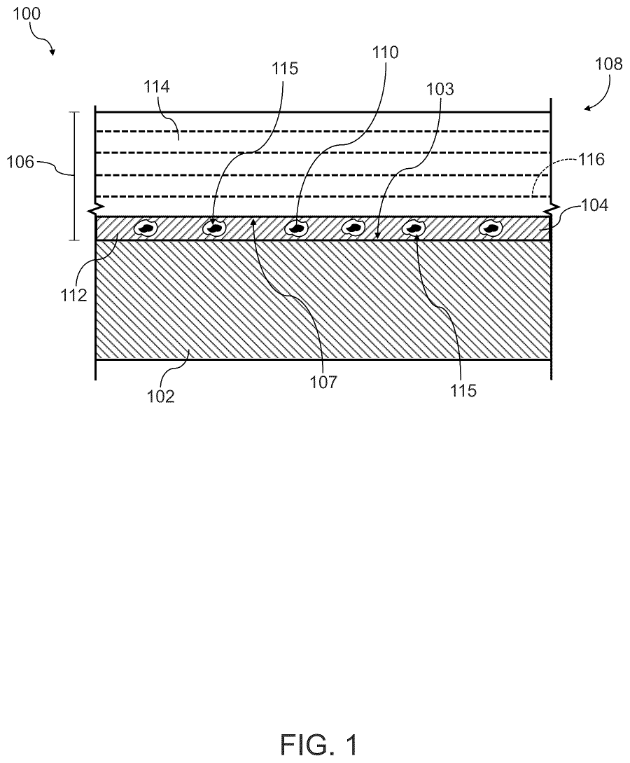

Referring to FIG. 1, an exemplary coated component 100 is shown formed from a substrate 102 having a surface 103 with a coating system 106 thereon. The substrate 102 is formed from a ceramic material, such as a CMC or a monolithic ceramic material (i.e., materials without fiber reinforcement, such as having the matrix material only). Herein, CMCs and monolithic ceramics are collectively referred to as “ceramics.” In embodiments, the CMC substrate 102 includes silicon carbide (SiC) within its ceramic matrix and fibers (when present).

Generally, the coating system 106 includes a bondcoat 104 on the surface 103 of the substrate, and an EBC 108 on the bondcoat 104. In the embodiment shown, the bondcoat 104 is directly on the surface 103 without any layer therebetween. The EBC 108 is discussed in greater detail below.

In the exemplary embodiment of FIG. 1, the bondcoat 104 has a matrix phase 112 with a plurality of oxygen getter particulates 110 dispersed therein and with a plurality of pores 115 dispersed therein. Most of the oxygen getter particulates 110 are disposed within (i.e., positioned within) a corresponding pore 115 such that the oxygen getter particulates 110 are exposed to a space within a pore 115. The oxygen getter particulates 110 is generally defined within the matrix phase 112 as a plurality of discrete particles.

A pore 115 generally refers to an absence of matrix phase 112 in the bondcoat 104 with a diameter that is greater than the as-deposited porosity, such as greater than 15 μm. The absence of matrix phase 112 does not preclude the presence of gas or other solid material, such one or more oxygen-getter particulates 110. A pore 115 has a perimeter generally defined by the matrix phase 112. An oxygen-getter particulates 110 within the perimeter of a pore 115 may contact the matrix phase 112. For example, a pore 115 may be exposed to a gas or air pocket within the pore 115 for at least 50%-75% of its defining surface by the matrix phase 112. A pore 115 generally has a greater average diameter than the one or more oxygen-getter particulates 110 dispersed therein.

Thus, the matrix phase 112 may be relatively high density while still being resistant to low-temperature oxidation cracking, due to the presence of the pores 115 therein. When mullite-Si are the only components of the bondcoat, the art to use pressurized sintering to achieve near-full density. Alternatively, sintering aids were added to the mullite-Si composite to facilitate liquid phase sintering to obtain near-full density.

The plurality of pores 115 are distributed in the matrix phase 112 with a majority of the discrete oxygen getter particulates 110 being dispersed within a pore 115 defined within the matrix phase 112. For example, at least 75% of the discrete oxygen getter particulates 110are positioned within a respective pore 115 within the matrix phase 112. Due to the nature of how the pores 115 are formed, a single oxygen getter particulate 110 may be positioned within each pore 115, with exceptions for adjacent pores 115 forming a larger, conglomerate cavity (of more than one pore 115). For example, each of the at least 75% of the oxygen getter particulates 110 may be positioned within its respective pore 115 such that each pore 115 includes a oxygen getter particulate 110 (e.g., a single oxygen getter particulate 110). However, in certain embodiments, adjacent pores 115 may form a larger pore conglomerate that then may include more than one oxygen getter particulate 110 within the pore conglomerate. Thus, each pore of the plurality of pores may contain a respective oxygen getter particulate 110. For example, 75% of the plurality of pores may contain a single oxygen getter particulate 110.

In embodiments, the oxygen getter particulates 110 includes a silicon-based oxygen getter, such as silicon in the form of elemental silicon (e.g., pure elemental silicon), a silicon alloy (e.g., a silicon eutectic alloy), a silicide with a melting point of about 1500° C. or less, or mixtures thereof. Alternatively, the oxygen getter particulates 110 may include a non-silicon-containing oxygen getter, such as nickel, cobalt, chromium, or mixtures thereof. In embodiments, these non-silicon-containing oxygen getters may also be used with a silicon-based oxygen getter (e.g., elemental silicon, a silicon alloy, and/or a silicide). In embodiments, the bondcoat 104 includes 1% by weight to 40% by weight of the oxygen getter particulates 110.

Depending on the particular composition, the oxygen getter particulates 110 may melt at temperatures of about 1400° C. to about 1500° C., depending on the composition of the oxygen getter particulates 110, so as to become molten. For example, the oxygen getter particulates 110 may have a melting temperature of about 1414° C. (i.e., the melting point of elemental silicon) to about 1485° C. In embodiments, the oxygen getter particulates 110 may be formed from a silicon material that is molten at a bondcoat temperature of 1415° C., 1425° C., 1450° C., 1475° C., and/or 1500° C. In certain embodiments, a silicide has a melting point of about 1500° C. or greater. Determining the melting point of a particular silicide may be easily achieved using Si phase diagrams.

In some embodiments, the oxygen getter particulates 110 is contained within the bondcoat 104, upon melting in use at operating conditions above the melting temperature of the composition of the oxygen getter. For instance, the oxygen getter particulates 110 may be contained within the matrix phase 112 between the surface 103 of the substrate 102 and an inner surface 107 of the environmental barrier coating 108. That is, the matrix phase 112 may form a 3-dimensional network that spans the thickness of the bondcoat 104 and is bonded to the surface 103 of the substrate 102 and the inner surface 107 of the environmental barrier coating 108. As such, the matrix phase 112 works with the surface 103 of the substrate 102 and the environmental barrier coating 108 to contain the melted oxygen getter particulates 110 therein while keeping the integrity of the bondcoat 104 without delamination from the surface 103 of the substrate 102.

In embodiments, the matrix phase 112 comprises mullite, such as crystallized mullite having a melting temperature that is greater than the matrix phase 112. In embodiments, mullite has a melting temperature that is about 1825° C. to 1860° C. (e.g., about 1840° C.), and is generally unreactive with the oxygen getter material of the oxygen getter particulates 110 (e.g., elemental silicon). In embodiments, the matrix phase 112 may contain an excess of alumina, up to about 10 mole % of excess alumina. For example, the matrix phase 112 may include alumina and silica in a stoichiometric ratio of about 3 to 2 up to about 3.5 to 2 or in a stoichiometric ratio of about 2 to 1 up to about 2.25 to 1. In another embodiment, the matrix phase 112 may contain an excess of silica.

In embodiments, the bondcoat 104 is formed from a silicon-based oxygen getter particulates (e.g., elemental silicon) contained within a matrix phase 112 of mullite. In such an embodiment, the elemental silicon within mullite may melt during operation of the coated component, while remaining contained within the mullite phase and retaining the functions of the bondcoat, including, but are not limited to, bonding the substrate to the EBC thereon and gettering of oxygen without releasing gas to prevent oxidation of the underlying substrate that would otherwise result in a gaseous by-product. Thus, a liquid silicon-phase may be utilized within the bondcoat during operation of the coating component (e.g., within a gas turbine engine). Since the bondcoat continues to function above the melting point of the silicon-phase, the coated component can be operated at temperatures above the melting point of the silicon-phase.

The matrix phase 112 is included in the bondcoat 104 in an amount to provide structural integrity to the bondcoat 104 while the oxygen getter particulates 110 (e.g., of silicon) is melted at operating temperatures above the melting point of elemental silicon (i.e., about 1414° C.). As such, the matrix phase 112 may define at least 60% of the bondcoat 104. In embodiments, the bondcoat 104 may include the matrix phase 112 in 60% to 98% by volume, such as 65% to 96% by volume (e.g., 75% to 95% by volume mullite). In the embodiment shown, the matrix phase 112 defines a continuous matrix throughout the bondcoat 104.

Conversely, the oxygen getter particulates 110 is included in the bondcoat 104 in an amount sufficient to scavenge oxygen reaching the bondcoat 104. For example, the bondcoat 104 may, in certain embodiments, include 2% to 40% by volume of the oxygen getter particulates 110, such as 4% to 35% by volume of the oxygen getter particulates 110 (e.g., 5% to 25% by volume of the oxygen getter particulates 110). In embodiments, for example, the oxygen getter particulates 110 may include 5% to 40% by volume of elemental silicon, such as about 7% to 35% by weight of elemental silicon (e.g., 5% to 25% by volume of elemental silicon).

Mullite generally has a relatively slow diffusion rate for oxygen at all temperatures of interest, even up to about 1650° C. (e.g., about 1200° C. to about 1650° C.). At temperatures over about 1200° C., it is believed that the only other crystalline oxide that has lower oxygen diffusion rate than mullite is alumina, which has a very high expansion coefficient compared to the substrate and cannot be deposited as dense coatings without spallation. Although mullite has a coefficient of thermal expansion (“CTE”) that is similar to that of SiC CMC substrates 102, the CTE of mullite is not an exact match to SiC. The slight mismatch of CTE of mullite and SiC could lead to problems related to thermal expansion, such as cracking and/or delamination, if the bondcoat 104 is too thick. For example, it is believed that a bondcoat 104 having a thickness of 20 mils (i.e., 508 μm) would lead to problems related to the CTE mismatch after repeated exposure to the operating temperatures. On the other hand, it is believed that a bondcoat 104 having a maximum thickness of 10 mils or less, such as 1 mil to 10 mils (i.e., 254 μm or less, such as 25.4 μm to 254 μm), would survive such operating temperatures without significant problems from the CTE mismatch. In one particular embodiment, the bondcoat 104 has a maximum thickness of 5 mils, such as 3 mils to 5 mils (i.e., 127 μm, such as 76.2 μm to 127 μm).

Without wishing to be bound by any particular theory, it is believed that the oxygen getter particulates 110 expands in volume upon contact and reaction with oxygen (“oxidation expansion”), which may cause the matrix phase 112 (including mullite) to experience tensile stress, particularly at lower temperatures. This oxidation expansion may then lead to micro-cracking within the bondcoat 104, that could then serve to allow for faster oxidation in subsequent exposure to oxygen. However, the pores 115 containing the oxygen getter particulates 110 provides open volume or space for such oxidation expansion. That is, when oxidation of the oxygen getter particulates 110 occurs, the volume expansion is accommodated by the space of the pores 115, thus reducing or eliminating tensile stress that would have otherwise been experienced by the bondcoat 104, which in turn inhibits or prevents micro-cracking of the bondcoat 104.

As stated, the bondcoat 104 includes the plurality of pores 115 containing a majority of the oxygen getter particulates 110 within the matrix phase 112. In embodiments, the oxygen getter particulates 110 has a getter volume fraction within the bondcoat 104. The bondcoat 104 has, in embodiments, a porosity defined by the plurality of pores 115 that is 50% to 200% of the getter volume fraction. The pores 115 may have a size that is relatively large, such as having an average diameter of 15 μm to 100 μm, so as to provide sufficient mechanical compliance to the bondcoat 104. Thus, the pores 115 are much larger than, and are not to be confused with, any porosity within the as-deposited matrix material prior to a sintering process that densifies the as-deposited matrix material.

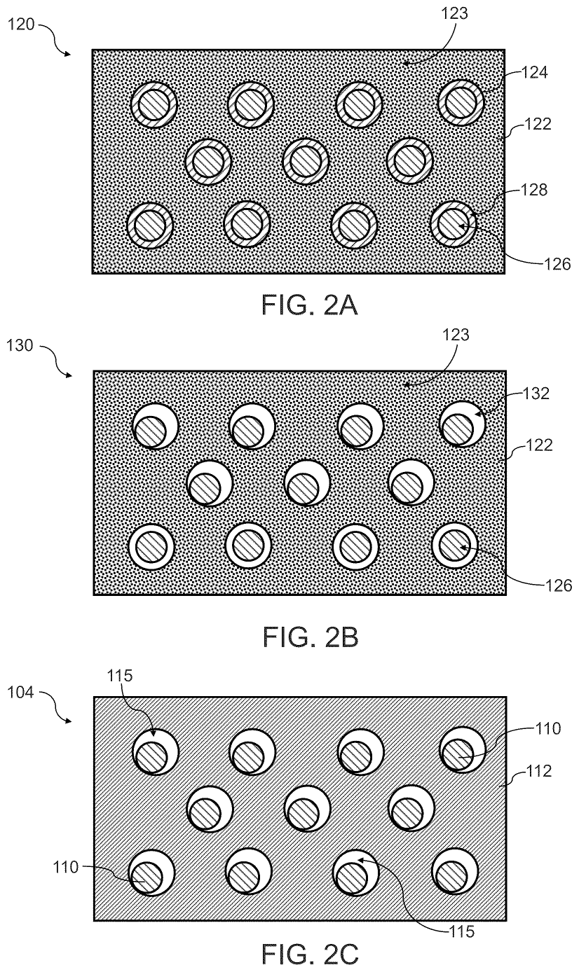

FIGS. 2A, 2B and 2C sequentially show an exemplary bondcoat 104 (FIG. 1) being formed through sequential stages of an exemplary as-deposited bondcoat mixture 120 (FIG. 2A); the exemplary bondcoat mixture 130 after a first heat treatment (FIG. 2B), and the resulting bondcoat 104 after a second heat treatment (FIG. 2C).

Referring to FIG. 2A, an exemplary as-deposited bondcoat mixture 120 is shown including a matrix material 122 with a plurality of bimodal particles 124 dispersed therein. The bimodal particles 124 generally comprise an oxygen getter and a sacrificial material. Depending on the deposition process utilized, the as-deposited bondcoat mixture 120 may have an as-deposited porosity within the matrix material 122. This as-deposited porosity within the matrix material 122 is generally defined by relatively small pores 123 within the matrix material 122, such as having an average diameter that is less than 5 μm (e.g., 0.5 μm to 5 μm).

In the embodiment of FIG. 2A, the bimodal particles 124 are in the form of core-shell particles, each having a core 126 comprising the oxygen getter and a shell 128 comprising the sacrificial material. In embodiments, the oxygen getter and the sacrificial material are present in a ratio of 30%-200% by volume as deposited (i.e., the oxygen getter is present in a getter volume that is 30% to 200% of a sacrificial volume of the sacrificial material).

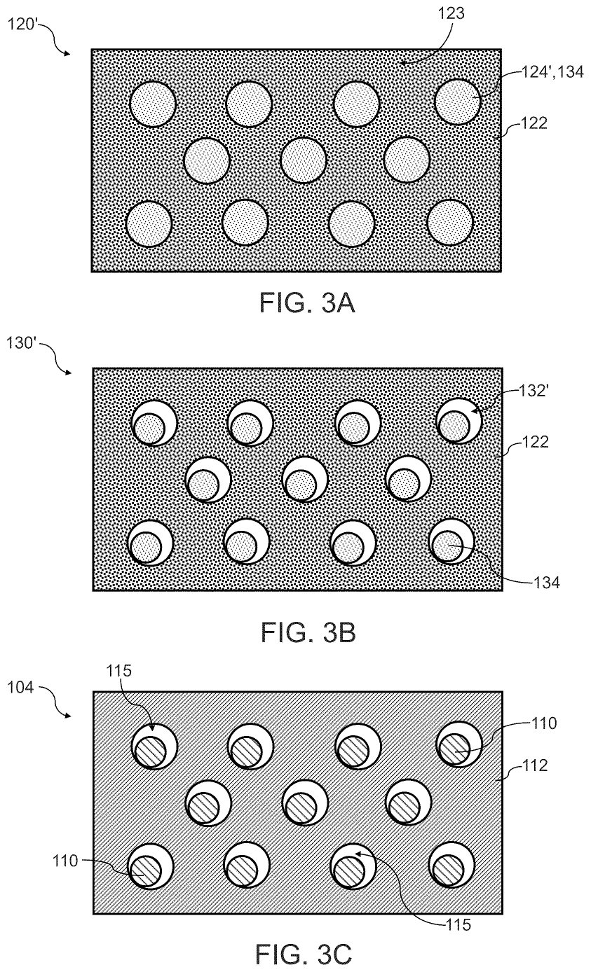

The as-deposited bondcoat mixture 120 of FIG. 2A may be subjected to a first heat treatment to sufficiently burn outthe sacrificial material from the bimodal particles 124 to form a bondcoat mixture 130 with voids 132 therein. As used here, “sufficiently burn out” refers to decomposing or removing the sacrificial material in an amount to form a void 132 within the as-deposited matrix material 112. For example, the “sufficiently burn out” may refer to decomposing or removing at least 90% of the sacrificial material from the as-deposited matrix material 122. Generally, the first heat treatment is performed at a first heat treatment temperature that is sufficient to burn out (e.g., decompose, sufficiently remove, etc.) the sacrificial material from the bondcoat mixture 130, while retaining the as-deposited porosity within the as-deposited matrix material 122. The sacrificial material may escape the as-deposited matrix material 122 via its as-deposited porosity defined by the relatively small pores 123. For instance, the first heat treatment temperature may be 500° C. to 800° C. Thus, the sacrificial material of the shell 128 may form voids 132 in the place of the shell 128 such that the voids 132 are adjacent to the cores 126 remaining dispersed within the as-deposited matrix material 122. The voids 132 are significantly larger than the relatively small pores 123 (FIG. 3A) within the as-deposited matrix material 122 defining the as-deposited porosity.

Generally, the sacrificial material of the shells 128 may be a carbon-based material configured to decompose and/or vaporize at the first heat treatment temperature. For instance, the sacrificial material of the shells 128 may be a polymeric material, carbon black, or another carbon-based material that decomposes or vaporizes at first heat treatment temperature. The as-deposited porosity within the matrix material 122 allows for the sacrificial material of the shells 128 to vaporize and escape from the bondcoat mixture 130.

The bondcoat mixture 130 with voids 132 adjacent to the cores 126 dispersed within the as-deposited matrix material 122 of FIG. 2B may then be subjected to a second heat treatment to sinter the as-deposited matrix material 122 to form the matrix phase 112 with the oxygen getter particulates 110 and the plurality of pores 115 dispersed therein such that each pore 115 includes a plurality of oxygen getter particulates 110. Generally, the second heat treatment is performed at a second heat treatment temperature sufficient to densify the as-deposited matrix material 122 to significantly reduce or eliminate the as-deposited porosity from the as-deposited matrix material 122 to form the matrix phase 112. In embodiments, the relatively small pores 123 within the as-deposited matrix material 122 defining the as-deposited porosity (FIG. 2B) are removed in the second heat treatment so that the matrix phase 112 (FIG. 2C) has no significant porosity therein, other than the pores 115. The pores 115 may have an average diameter of 10 μm to 100μm, such as 10 μm to 50 μm. As shown, the plurality of pores 115 are distributed in the matrix phase 112 such that a majority of the oxygen getter particulates 110 within the matrix phase 112. As stated above, at least 75% of the oxygen getter particulates 110 are positioned in a respective pore 115 within the matrix phase 112.

Generally, the second heat treatment temperature is greater than the first heat treatment temperature. In embodiments, the second heat treatment temperature may be 1415° C. or greater, such as 1415° C. to 1600° C. (e.g., 1450° C. to 1600° C.).

FIGS. 3A, 3B and 3C sequentially show an exemplary bondcoat 104 (FIG. 1) being formed through sequential stages of an exemplary as-deposited bondcoat mixture 120′ (FIG. 3A); the exemplary bondcoat mixture 130′ after a first heat treatment (FIG. 3B), and the resulting bondcoat 104 after a second heat treatment (FIG. 3C). The embodiment of FIGS. 3A, 3B and 3C is similar to that of FIGS. 2A, 2B and 2C, with the type of bimodal particles being different. Otherwise, the discussion of FIGS. 2A, 2B and 2C is applicable to FIGS. 3A, 3B and 3C.

Referring to FIG. 3A, the exemplary as-deposited bondcoat mixture 120′ is shown including a matrix material 122 with a plurality of bimodal particles 124′ dispersed therein. The bimodal particles 124′ generally comprise an oxygen getter and a sacrificial material. Depending on the deposition process utilized, the as-deposited bondcoat mixture 120′ may have an as-deposited porosity within the matrix material 122. This as-deposited porosity within the matrix material 122 is generally defined by relatively small pores 123 within the matrix material 122, such as having an average diameter that is less than 5 μm (e.g., 0.5 μm to 5 μm).

In the embodiment of FIG. 3A, the bimodal particles 124′ are in the form of intermixed particles 134 that include both the oxygen getter and the sacrificial material therein. In embodiments, the oxygen getter and the sacrificial material are present in a ratio of 30%-200% by volume as deposited (i.e., the oxygen getter is present in a getter volume that is 30% to 200% of a sacrificial volume of the sacrificial material).

The as-deposited bondcoat mixture 120 of FIG. 3A may be subjected to a first heat treatment to remove the sacrificial material from the bimodal particles 124′ to form a bondcoat mixture 130′ with voids 132′ therein. Generally, the first heat treatment is performed at a first heat treatment temperature that is sufficient to remove the sacrificial material is removed from the bondcoat mixture 130′, while retaining the as-deposited porosity within the as-deposited matrix material 122. For instance, the first heat treatment temperature may be 500° C. to 800° C. Thus, the sacrificial material may form voids 132′. The voids 132′ are significantly larger than the relatively small pores 123 within the as-deposited matrix material 122 defining the as-deposited porosity.

Generally, the sacrificial material of the intermixed particles 134 may be a carbon-based material configured to decompose and/or vaporize at the first heat treatment temperature. For instance, the sacrificial material of the intermixed particles 134 may be a polymeric material, carbon black, or another carbon-based material that decomposes or vaporizes at first heat treatment temperature. The as-deposited porosity within the matrix material 122 allows for the sacrificial material of the intermixed particles 134 to vaporize and escape from the bondcoat mixture 130′.

The bondcoat mixture 130′ with voids 132′ adjacent to the cores 126′ dispersed within the as-deposited matrix material 122 of FIG. 3B may then be subjected to a second heat treatment to sinter the as-deposited matrix material 122 to form the matrix phase 112 with the oxygen getter particulates 110 and the plurality of pores 115 dispersed therein such that at least one oxygen getter particulates 110 is dispersed within a pore 115. Generally, the second heat treatment is performed at a second heat treatment temperature sufficient to densify the as-deposited matrix material 122 to significantly reduce or eliminate the as-deposited porosity from the as-deposited matrix material 122 to form the matrix phase 112. In embodiments, the relatively small pores 123 within the as-deposited matrix material 122 defining the as-deposited porosity (FIG. 3B) are removed in the second heat treatment so that the matrix phase 112 (FIG. 3C) has no significant porosity therein, other than the pores 115. The pores 115 may have an average diameter of 10 μm to 100 μm, such as 10 μm to 50 μm. Generally, the second heat treatment temperature is greater than the first heat treatment temperature. In embodiments, the second heat treatment temperature may be 1415° C. or greater, such as 1415° C. to 1600° C. (e.g., 1450° C. to 1600° C.). As shown, the plurality of pores 115 are distributed in the matrix phase 112 such that a majority of the oxygen getter particulates 110 within the matrix phase 112. As stated above, at least 75% of the oxygen getter particulates 110 are positioned in a respective pore 115 within the matrix phase 112.

Referring again to FIG. 1, the substrate 102 may be formed from a CMC material, such as a silicon-based, non-oxide ceramic matrix composite, no matter the particular bondcoat 104 or its method of formation utilized. The bondcoat 104 may be used in conjunction with an EBC 108 to form a coated component 100 with an increased operating temperature compared to that using only a silicon bondcoat (without the mullite phase). The EBC 108 may include any combination of one or more layers formed from materials selected from typical EBC or thermal barrier coating (“TBC”) layer chemistries, including but not limited to rare earth silicates (e.g., mono-silicates and di-silicates), aluminosilicates (e.g., mullite, barium strontium aluminosilicate (BSAS), rare earth aluminosilicates, etc.), hafnia, zirconia, stabilized hafnia, stabilized zirconia, rare earth hafnates, rare earth zirconates, rare earth gallium oxide, etc.

The EBC 108 may be formed from a plurality of individual layers 114. In embodiments, the EBC 108 may include a hermetic layer 116, such as directly on the bondcoat 104. In embodiments, this hermetic layer is of mullite, up to 2 mil thick, such as preferably about 0.1 mil to about 1 mil thick (e.g., about 0.1 mil to about 0.5 mil thick). Since the oxygen getter particulates 110 is reactive with oxygen to form silicon oxide, there is minimal gaseous oxides produced (e.g., carbon oxides) upon exposure of the component 100 to oxygen at operating temperatures. Thus, there is no need for a gas escape layer through the bondcoat 104, and the hermetic layer may be included within the EBC 108. In embodiments, it may be desirable to have a hermetic layer to prevent the ingress of water vapor to the bondcoat 104. In embodiments, the hermetic layer 116 may be positioned directly on the bondcoat 104, but may also be positioned elsewhere within the EBC 108. In embodiments, the EBC may include a hafnia layer, an alumina layer, a rare earth disilicate layer, a rare earth monosilicate layer, or combinations thereof.

The coated component 100 is particularly suitable for use as a component found in high temperature environments, such as those present in gas turbine engines, for example, combustor components, turbine blades, shrouds, nozzles, heat shields, and vanes. In particular, the turbine component can be a CMC component 100 positioned within a hot gas flow path of the gas turbine such that the coating system 106 forms an environmental barrier for the underlying substrate 102 to protect the component 100 within the gas turbine when exposed to the hot gas flow path. In certain embodiments, the bondcoat 104 is configured such that the coated component 100 is exposed to operating temperatures of about 1475° C. to about 1650° C.

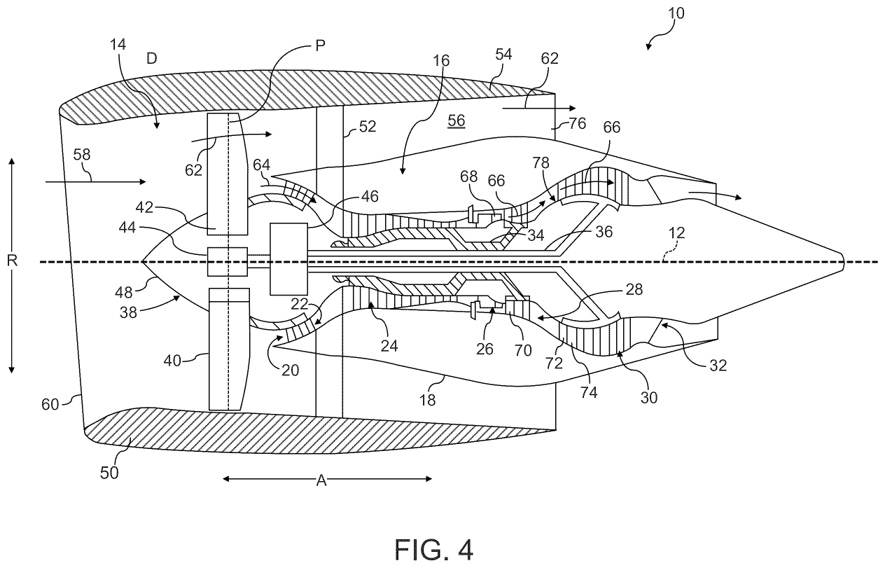

FIG. 4 is a schematic cross-sectional view of a gas turbine engine in accordance with an exemplary embodiment of the present disclosure. More particularly, for the embodiment of FIG. 4, the gas turbine engine is a high-bypass turbofan jet engine 10, referred to herein as “turbofan engine 10.” As shown in FIG. 4, the turbofan engine 10 defines an axial direction A (extending parallel to a longitudinal centerline 12 provided for reference) and a radial direction R. In general, the turbofan 10 includes a fan section 14 and a core turbine engine 16 disposed downstream from the fan section 14. Although described below with reference to a turbofan engine 10, the present disclosure is applicable to turbomachinery in general, including turbojet, turboprop and turboshaft gas turbine engines, including industrial and marine gas turbine engines and auxiliary power units. It is also applicable to other high temperature applications that contain water vapor in the gas phase, such as those arising from combustion of hydrocarbon fuels.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

For the embodiment depicted, the fan section 14 includes a variable pitch fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40 in unison. The fan blades 40, disk 42, and actuation member 44 are together rotatable about the longitudinal axis 12 by LP shaft 36 across an optional power gear box 46. The power gear box 46 includes a plurality of gears for stepping down the rotational speed of the LP shaft 36 to a more efficient rotational fan speed.

Referring still to the exemplary embodiment of FIG. 4, the disk 42 is covered by rotatable front nacelle 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that the nacelle 50 may be configured to be supported relative to the core turbine engine 16 by a plurality of circumferentially-spaced outlet guide vanes 52. Moreover, a downstream section 54 of the nacelle 50 may extend over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

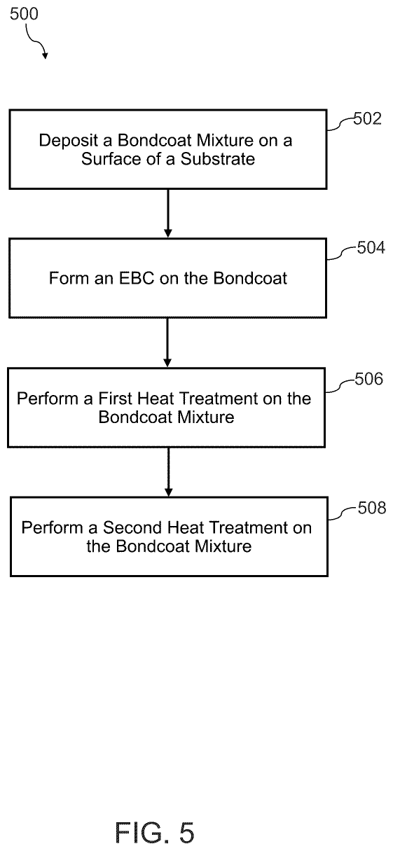

Methods are also generally provided for coating a ceramic component. For example, FIG. 5 shows a diagram of an exemplary method 500 of forming a coating component. At 502, a bondcoat mixture is deposited on a surface of a substrate such that the bondcoat mixture comprises a plurality of bimodal particles dispersed within a matrix material, with the bimodal particles comprise an oxygen getter and a sacrificial material, such as described above.

In embodiments, the bondcoat mixture is deposited by air plasma spray. In another embodiment, it is formed by suspension plasma spray where a liquid suspension of the desired chemistry is used for air plasma spray. In still another embodiment, the bondcoat mixture is deposited by low pressure plasma spray. In yet another embodiment, the bondcoat mixture is deposited by a slurry coating process. At 504, an EBC is formed on the bondcoat mixture. The EBC may be a single layer or may include multiple layers, as described above.

At 506, a first heat treatment is performed on the bondcoat mixture at a first treatment temperature such that the sacrificial material is removed from the bondcoat, such as described above with respect to FIGS. 2A-2C and 3A-3C. Thereafter, at 508, a second heat treatment is performed on the bondcoat mixture at a second treatment temperature such that the matrix material sinters to form a matrix phase with a plurality of oxygen getter particulates and a plurality of pores distributed therein such that a majority of the oxygen getter particulates are dispersed within a pore defined within the matrix phase, such as described above with respect to FIGS. 2A-2C and 3A-3C.,

It is noted that the first heat treatment and second heat treatment may be performed before or after the formation of the EBC on the bondcoat.

In view of the above, coated components described herein may include a bondcoat having a plurality of oxygen getter particulates dispersed within pores defined by a matrix phase. The bondcoat may generally add a measure of mechanical compliance to the coating to allow accommodation of strains due to thermal stresses among the various materials present in the coating system and between the substrate and the coating system. For example, microcracking after any oxidation expansion may be inhibited.

Further aspects are provided by the subject matter of the following clauses:

A coated component, comprising: a ceramic matrix composite substrate comprising silicon carbide and having a surface; a bondcoat on the surface of the ceramic matrix composite substrate, wherein the bondcoat comprises a matrix phase having a plurality of oxygen getter particulates dispersed within the matrix phase and having a plurality of pores dispersed within the matrix phase such that a majority of the oxygen getter particulates are disposed within a respective pore of the plurality of pores; and an environmental barrier coating on the bondcoat.

The coated component as in any preceding clause, wherein 75% of the plurality of pores contain a single oxygen getter particulate.

The coated component as in any preceding clause, wherein the oxygen getter particulates have a getter volume fraction within the bondcoat, and wherein the bondcoat has a porosity that is 50% to 200% of the getter volume fraction.

The coated component as in any preceding clause, wherein the porosity includes pores having an average diameter of 15 μm to 100 μm.

The coated component as in any preceding clause, wherein the matrix phase comprises mullite.

The coated component as in any preceding clause, wherein the mullite contains an excess of alumina.

The coated component as in any preceding clause, wherein the mullite contains an excess of silica.

The coated component as in any preceding clause, wherein the bondcoat includes 1% by weight to 40% by weight of the oxygen getter particulates.

The coated component as in any preceding clause, wherein the oxygen getter particulates comprises elemental silicon, a silicon alloy, a silicide, or a mixture thereof.

The coated component as in any preceding clause, wherein the matrix phase is a continuous phase, and wherein the matrix phase spans the bondcoat and bonds directly to the surface of the ceramic matrix composite substrate and to an inner surface of the environmental barrier coating.

The coated component as in any preceding clause, wherein the matrix phase defines 60% to 98% by volume of the bondcoat.

The coated component as in any preceding clause, wherein the environmental barrier coating comprises a plurality of layers with at least one of the layers of the environmental barrier coating comprises a hermetic layer.

The coated component as in any preceding clause, wherein the hermetic layer is adjacent to the bondcoat such that the hermetic layer defines an inner surface of the environmental barrier coating.

The coated component as in any preceding clause, wherein the bondcoat is configured to withstand exposure to operating temperatures of 1475° C. to 1650° C.

The coated component as in any preceding clause, wherein the environmental barrier coating comprises a hafnia layer, an alumina layer, a rare earth disilicate layer, a rare earth monosilicate layer, or a combination thereof.

A method of forming a coated component, the method comprising: depositing a bondcoat mixture on a surface of a substrate, wherein the bondcoat mixture comprises a plurality of bimodal particles dispersed within a matrix material, wherein the bimodal particles comprise an oxygen getter and a sacrificial material; forming an environmental barrier coating on the bondcoat mixture; performing a first heat treatment on the bondcoat mixture at a first treatment temperature such that the sacrificial material is sufficiently burned out from the bondcoat mixture; and thereafter, performing a second heat treatment on the bondcoat mixture at a second treatment temperature such that the matrix material sinters to form a matrix phase with oxygen getter particulates dispersed within a plurality of pores in the matrix phase, wherein the second treatment temperature is greater than the first treatment temperature.

The method as in any preceding clause, wherein the first treatment temperature is 500° C. to 800° C., and wherein the second treatment temperature is 1415° C. to 1600° C.

The method as in any preceding clause, wherein the sacrificial material comprises a polymeric material, carbon black, or a mixture thereof.

The method as in any preceding clause, wherein the plurality of bimodal particles, prior to heat treatment, comprises core-shell particles having a shell surrounding a core, wherein the core comprises the oxygen getter, and wherein the shell comprises the sacrificial material.

The method as in any preceding clause, wherein the plurality of bimodal particles, prior to heat treatment, comprises intermixed particles comprising the oxygen getter and the sacrificial material.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A coated component, comprising:
a ceramic matrix composite substrate comprising silicon carbide and having a surface;
a bondcoat on the surface of the ceramic matrix composite substrate, wherein the bondcoat comprises a matrix phase having a plurality of oxygen getter particulates dispersed within the matrix phase and having a plurality of pores dispersed within the matrix phase such that a majority of the oxygen getter particulates are disposed within a respective pore of the plurality of pores; and
an environmental barrier coating on the bondcoat.

2. The coated component as in claim 1, wherein 75% of the plurality of pores contain a single oxygen getter particulate.

3. The coated component as in claim 1, wherein the oxygen getter particulates have a getter volume fraction within the bondcoat, and wherein the bondcoat has a porosity that is 50% to 200% of the getter volume fraction.

4. The coated component as in claim 3, wherein the porosity includes pores having an average diameter of 15 μm to 100 μm.

5. The coated component as in claim 1, wherein the matrix phase comprises mullite.

6. The coated component as in claim 5, wherein the mullite contains an excess of alumina.

7. The coated component as in claim 5, wherein the mullite contains an excess of silica.

8. The coated component as in claim 1, wherein the bondcoat includes 1% by weight to 40% by weight of the oxygen getter particulates.

9. The coated component as in claim 1, wherein the oxygen getter particulates comprises elemental silicon, a silicon alloy, a silicide, or a mixture thereof.

10. The coated component as in claim 1, wherein the matrix phase is a continuous phase, and wherein the matrix phase spans the bondcoat and bonds directly to the surface of the ceramic matrix composite substrate and to an inner surface of the environmental barrier coating.

11. The coated component as in claim 1, wherein the matrix phase defines 60% to 98% by volume of the bondcoat.

12. The coated component as in claim 1, wherein the environmental barrier coating comprises a plurality of layers with at least one of the layers of the environmental barrier coating comprises a hermetic layer.

13. The coated component as in claim 12, wherein the hermetic layer is adjacent to the bondcoat such that the hermetic layer defines an inner surface of the environmental barrier coating.

14. The coated component as in claim 1, wherein the bondcoat is configured to withstand exposure to operating temperatures of 1475° C. to 1650° C.

15. The coated component as in claim 1, wherein the environmental barrier coating comprises a hafnia layer, an alumina layer, a rare earth disilicate layer, a rare earth monosilicate layer, or a combination thereof.

16. A method of forming a coated component, the method comprising:
depositing a bondcoat mixture on a surface of a substrate, wherein the bondcoat mixture comprises a plurality of bimodal particles dispersed within a matrix material, wherein the bimodal particles comprise an oxygen getter and a sacrificial material;
forming an environmental barrier coating on the bondcoat mixture;
performing a first heat treatment on the bondcoat mixture at a first treatment temperature such that the sacrificial material is sufficiently burned out from the bondcoat mixture; and
thereafter, performing a second heat treatment on the bondcoat mixture at a second treatment temperature such that the matrix material sinters to form a matrix phase with oxygen getter particulates dispersed within a plurality of pores in the matrix phase, wherein the second treatment temperature is greater than the first treatment temperature.

17. The method as in claim 16, wherein the first treatment temperature is 500° C. to 800° C., and wherein the second treatment temperature is 1415° C. to 1600° C.

18. The method as in claim 16, wherein the sacrificial material comprises a polymeric material, carbon black, or a mixture thereof.

19. The method as in claim 16, wherein the plurality of bimodal particles, prior to heat treatment, comprises core-shell particles having a shell surrounding a core, wherein the core comprises the oxygen getter, and wherein the shell comprises the sacrificial material.

20. The method as in claim 16, wherein the plurality of bimodal particles, prior to heat treatment, comprises intermixed particles comprising the oxygen getter and the sacrificial material.
